(19) United States
(12) Patent Application Publication
(10) Pub. No.: US 2018/0218642 A1
(43) Pub. Date: Aug. 2, 2018

(54) Altered Vision Via Streamed Optical Remapping

(71) Applicant: BAYLOR COLLEGE OF MEDICINE, Houston, TX (US)

(72) Inventors: Muhammad Saad SHAMIM, Houston, TX (US); Suhas Surya Pilibail RAO, Houston, TX (US); Ido MACHOL, Houston, TX (US); Erez Lieberman AIDEN, Houston, TX (US)

(21) Appl. No.: 15/506,104

(22) PCT Filed: Sep. 2, 2015
(86) PCT No.: PCT/US2015/048150

§ 371 Date: Feb. 23, 2017

Related U.S. Application Data
(60) Provisional application No. 62/044,973, filed on Sep. 2, 2014.

(51) Int. Cl. G09B 21/00; G02C 7/04; G02C 11/00; G06T 3/60; G06T 3/00; G06T 3/20; G06T 5/00

(52) U.S. Cl. CPC G09B 21/008; G02C 7/04; G02C 11/10; G06T 3/60; G06T 2207/10024; G06T 3/20; G06T 5/009; G02C 2202/10; G06T 3/0093

(57) ABSTRACT

Devices and methods for personalized real time optical remapping of streamed content are provided. The personalized optical remapping can correct for a wide variety of visual deficiencies or preferences by manipulating visual and spatial elements of streamed content. A device for presenting a personalized visual feed to a user includes a sensor module for detecting a visual input and providing a visual feed, a transformation module performing a computational transformation, selected according to a visual deficit or personal preference of the user, on at least a portion of the visual feed producing a personalized visual feed, and a visual display presenting the personalized visual feed to the user.

### RELATED APPLICATION

This application is a claims the benefit of U.S. Provisional Application No. 62/044,973, filed on Sep. 2, 2014.

The entire teachings of the above application are incorporated herein by reference.

### BACKGROUND OF THE INVENTION

According to the NIH, “Most Americans report that, of all disabilities, loss of eyesight would have the greatest impact on their daily life, according to a recent survey by the NIH's National Eye Institute (NEI). Vision loss ranks ahead of loss of memory, speech, arm or leg, and hearing. After all, 80 percent of the sensory information the brain receives comes from our eyes.” How to Keep Your Sight for Life, NIH Medline Plus, Volume 3, Number 3, Page 12 (Summer 2008).

Loss of vision or of visual acuity can result from an enormous number of visual disorders, ranging from relatively minor disorders like myopia to much more serious conditions like age-related macular degeneration and glaucoma. A small subset of these disorders, including myopia and astigmatism, can be addressed using traditional corrective lenses, i.e. by transforming light in accordance with Snell's law of refraction. There remain, however, several visual deficits for which no proper corrections have been developed.

There has been progress in recent years to correct for visual problems not correctable by traditional glasses. McPherson et al. (WO2012119158 A1) disclose a method for calculating the construction of physical filters for removal of certain wavelengths. This allows for creation of special glasses for individuals with colorblindness as well as specialized glasses for protective industrial applications.

Fu Chung Huang describes a light field display which allows for correction of visual deficits through the use of specialized screen displays. Fu-Chung Huang, A Computational Light Field Display for Correcting Visual Aberrations, Univ. Calif. Berkeley, Tech. Rep. UCB/EECS-2013-206 (Dec. 15, 2013). The light field display controls the direction of light emission to allow for correction of certain high order visual aberrations. However, light field displays do not correct for vision deficiencies except in the context of viewing the specific electronic device.

Recently, much attention has been devoted to the potential of virtual reality and computer mediated reality devices for a variety of uses. Oculus Rift has gained much popularity in providing a platform for viewing virtual reality applications. Others have developed headsets, such as Google Cardboard and Durovis Dive, capable of mounting a Smartphone for simulation of virtual reality. Google Glass was developed for augmented reality.

While not well studied, social media has documented instances of individuals using virtual reality therapy for correction of stereoblindness, the inability of an individual to view objects in 3D. James Blaha, et al. have developed software on Oculus Rift aimed at assisting individuals with stereoblindness and providing therapy through a 3D game format (Diplopia—A VR Game for Strabismus and Amblyopia, https://www.indiegogo.com/projects/diplopia-a-vr-game-to-for-strabismus-and-amblyopia).

### SUMMARY OF THE INVENTION

A system and method for personalized real time optical remapping of streamed content, encompassing the use of mediated reality devices to address visual deficiencies and experience personalized manipulations of visual environments is provided. For example, a headset computing device of the present invention can replace traditional glasses and correct for a wider range of optical deficiencies in an inexpensive and accurate manner without the requirement of specialized advanced displays.

A device for presenting a personalized visual feed to a user comprises a sensor module including a visual sensor to detect a visual input. The sensor module provides a visual feed based on the detected visual input. The device further comprises a transformation module configured to receive the visual feed and perform a computational transformation on at least a portion of the received visual feed to produce a personalized visual feed. The computational transformation is selected according to a visual deficit or personal preference, or both, of the user. The device further comprises a visual display presenting the personalized visual feed to the user.

The visual display can be configured to be worn by the user. The visual feed can include a series of images and the transformation module can perform a computational transformation on at least a portion of each of the images. The visual display can include a light field display and/or a virtual retina display, and can provide a separate display for each eye of the user. In embodiments, the visual display is mounted on or within a contact lens.

The visual sensor can include one or more cameras which detect light in a visible spectrum and/or at least one spectral band other than a visible spectrum. The sensor module can include a non-visual sensor. Data from the non-visual sensor can be used, e.g., by the transformation module to produce the personalized visual feed. The non-visual sensor can include a microphone, GPS sensor, gyroscope, magnetometer, and/or compass. The transformation module can use the data from the non-visual sensor to augment the user's visual field by altering a portion of the visual feed to visualize data from the non-visible sensor.

The computational transformation can be selected according to a visual deficit of the user. The computational transformation can include a color transformation and/or a spatial distortion.

In one embodiment, the visual deficit is color blindness or color deficiency (e.g., protanopia, deuteranopia, tritanopia, protanomaly, deuteranomaly, and/or tritanomaly) and the computational transformation is a color transformation that results in the personalized visual feed providing improved color contrast for the user. In another embodiment, the visual deficit is macular degeneration, or visual distortions caused by other conditions or diseases, and the computational transformation is a spatial distortion that results in the personalized visual feed providing improved vision for the user. In a further embodiment, the visual deficit includes an optical aberration in one or both eyes of the user and the computational transformation corrects for the optical aberration.

The computational transformation can include spatially translating, spatially rotating, and/or spatially distorting at least a portion of the visual feed. The computational transformation can further include a linear or non-linear transformation of at least a portion of the visual feed. The transformation module can perform a computational transformation to produce a personalized visual feed for one eye of the user, and can perform a different computational transformation to produce a different personalized visual feed for the other eye of the user.

A wireless communication interface can be provided, e.g., included in the device. The sensor module, the transformation module and the visual display can communicate wirelessly via the wireless interface. For example, the sensor module and the visual display can be worn by the user, for example, as a headset or a pair of glasses, and be in wireless communication with a transformation module residing on a host computer.

The device can be a wearable device with at least one of, or all of, the sensor module, the transformation module and the visual display mounted to a headset configured to be worn by the user.

The device can include a diagnostic module that is configured to automatically select the computational transformation performed by the transformation module. Alternatively, or in addition, the computational transformation can be selected in an interactive process that includes automatically administering one or more eye tests to the user and determining at least one visual deficit and/or preference of the user. In an embodiment, the device further includes a selection module configured to enable selection of the computational transformation and the computational transformation is selected in response to user input.

A method for presenting a personalized visual feed to a user comprises providing a visual feed based on visual input detected by a visual sensor. The method further comprises, in at least one processor, receiving the visual feed from the visual sensor, or a visual sensor module that includes the visual sensor, and performing a computational transformation on at least a portion of the received visual feed to produce a personalized visual feed. The computational transformation is selected according a visual deficit or a personal preference, or both, of the user. The method further comprises presenting the personalized visual feed to the user on a visual display.

The method can further include providing at least one feed based on a non-visible input detected by a non-visual sensor. The non-visual sensor can include a microphone, GPS sensor, gyroscope, magnetometer, and compass.

The method can further include performing a diagnostic assessment of the user to automatically select the computational transformation. The diagnostic assessment can include automatically administering one or more eye tests to the user and determining a visual deficit of the user as a result of the one or more eye tests. An iterative process of presenting a first personalized visual feed to the user, receiving feedback from the user, performing an adjusted computational transformation based on the received feedback from the user to produce a second personalized visual feed, and presenting the second personalized visual feed to the user can be included in the diagnostic assessment.

A computer system for presenting a personalized visual feed to a user comprises a sensor module including a visual sensor to detect a visual input and a visual display, e.g. a visual display configured to be worn by the user. The sensor module provides a visual feed based on the detected visual input. The system further comprises at least one processor configured to receive the visual feed from the sensor module, perform a computational transformation on at least a portion of the received visual feed to produce a personalized visual feed, and present the personalized visual feed on the visual display to the user. The computational transformation is selected according a visual deficit or a personal preference, or both, of the user.

In a further embodiment, a system comprising a visual display, a data collection circuit to collect data, and a data processing circuit configured to transform the collected data and produce a display of the transformed collected data on the visual display is provided. The visual display includes a light field display and/or a virtual retina display. A diagnostic procedure for calculation of necessary data processing transformations can also be included in the system. The visual display can provide separate displays for each eye. At least one element of the system (e.g., the visual display, the data collection circuit, and/or the data processing circuit) can be mounted on the head of the user or mounted on or within a contact lens, or otherwise placed within the visual field of the user. Further, at least one element of the system (e.g., the visual display, the data collection circuit, and/or the data processing circuit) can communicate wirelessly with the other elements of the system. The system, or one element of the system, can contain a wireless data receiver.

The data collection circuit can include one or more cameras that detect light in the visible spectrum, and or light in other spectral bands, such as infrared or ultraviolet light. The data collection circuit can further include a microphone, and/or any other wearable sensors, such as a GPS sensor, a gyroscope, a magnetometer, and a compass.

In one embodiment, the data processing circuit transforms the color of individual pixels in order to facilitate improved color contrast in the visual field for users with protanopia, deuteranopia, and/or tritanopia. In another embodiment, the data processing circuit spatially distorts the image presented to one or both eyes to facilitate improved vision for users with macular degeneration. The data processing circuit can perform transformations to correct for optical aberrations in one or both eyes of a user. The data processing circuit can spatially translate, spatially rotate, spatially distort or transform the images presented to one or both eyes. The data processing circuit can further transform the color space of the images presented to one or both eyes. The data processing circuit can perform a linear or non-linear transformation of visual and/or spatial elements of the images presented to one or both eyes.

In further embodiments, diagnostic tools automating the process of constructing the necessary transformations for improving the user's vision are included in the devices and methods of the present invention.

If a non-visual sensor is included in a device or method, the device or method may or may not use or include a visual sensor. The non-visual sensor can be used in combination with the visual sensor to produce a visual feed. For example, a visual feed can be provided according to data from the non-visual sensor overlayed or mixed with data from the visual sensor. Alternatively, the visual feed can be provided with input from a non-visual sensor, without input from the visual sensor.

Embodiments of the invention have many advantages. For example, devices and methods of the present invention can correct for a wide variety of optical deficiencies on a personalized scale. The personalized visual feed(s) can be customized for an individual's exact deficiency or set of deficiencies. Further, the diagnostic module(s) can enable corrected vision for a user without requiring the user to visit an ophthalmologist or obtain a new pair of glasses with an updated prescription each time the user's vision changes. The user can adjust his or her personalized visual feed(s) as often as desired or needed. For example, if a user has a temporary vision defect, or a degrading or otherwise changing vision defect, the user can benefit from adjusting the transformation that is applied to the visual feed to produce a personalized visual feed that is best-suited to the user's needs or preferences at a particular time. Even for users without vision defects, a user may benefit from applying customized transformations at different times or under different circumstances. For example, a user may like to augment his or her vision with edge detection or motion detection highlighting at night.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1A and 1B are schematic views of a headset device according to embodiments of the present invention.

FIG. 2 is a flow diagram of an embodiment of the present invention.

FIG. 3 is a flow diagram illustrating an OpenGL pipeline for providing parallel processing.

FIGS. 4A-4D are graphs representing the absorption of long, medium, and short wavelengths in the visible spectrum for individuals with normal vision (A) and vision with color deficits (B), (C), and (D).

FIGS. 5A and 5B represent an example of (A) an Amsler grid of spatial distortions and (B) a perceived view of an individual with vision distorted according to FIG. 5A.

FIGS. 6A and 6B represent an example of (A) a user interface/diagnostic module of the present invention showing a user-manipulated Amsler grid for assessing a user's vision deficit; and (B) an example of a personalized visual feed presented to a user with distorted vision.

FIG. 7 is a flow chart representing an embodiment of the present invention.

FIG. 8 is a schematic view of a computer network embodying the present invention.

FIG. 9 is a block diagram of a computer node in the network of FIG. 8.

FIG. 10 represents a diagnostic module of the present invention.

### DETAILED DESCRIPTION OF THE INVENTION

A description of example embodiments of the invention follows.

The present invention relates to a device, system, and methods for personalized real time optical remapping of streamed content. A user wearing a device of the present invention is able to view an augmented environment in which visual deficiencies are corrected and other manipulations can be performed to provide a personalized viewing experience of the user's surroundings. A device of the present invention can correct for a number of conditions or optical deficiencies, such as drusen (yellow deposits under the retina, the light-sensitive tissue at the back of the eye) due to macular degeneration and blurred vision due to cataracts. The device of the present invention can also provide improved or enhanced vision for people with color-blindness. Such conditions may not be correctable through the use of ordinary glasses or corrective lenses. Vision enhancements can also be included for recreational use, such as color filtrations. Benefits of the present invention include the ability to correct for a diverse range of visual aberrations not presently corrected by traditional glasses. Devices, systems, and methods of the present invention can provide individuals with improved focus and contrast in their vision.

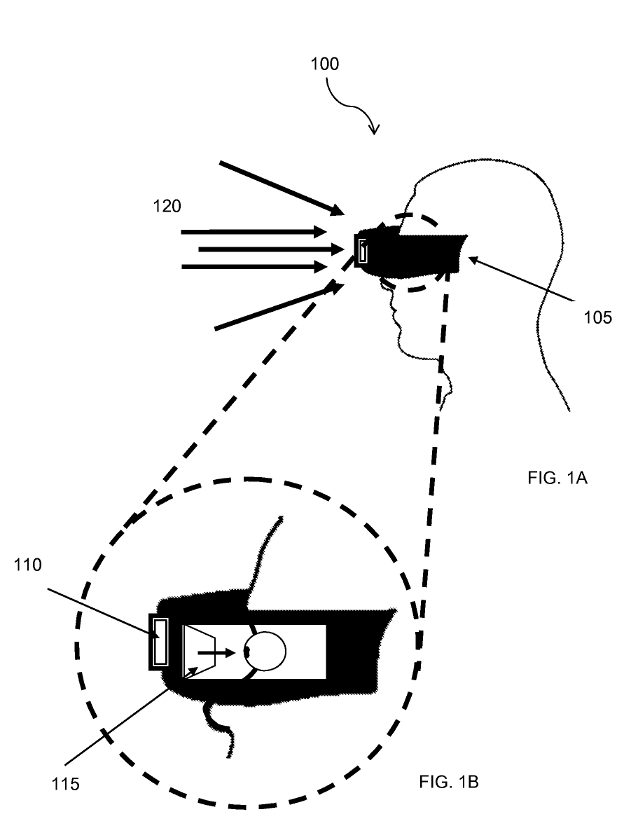

FIGS. 1A and 1B show an embodiment of the device 100 including headset 105. Light 120 is received by the camera 110 mounted to the headset 105 and provides a visual feed of the user's surroundings. Circuitry (not shown) internal to the headset transforms the raw visual feed captured by the camera 110 and presents a modified visual feed to the user on the visual display 115. Alternatively, the headset may include a wireless communication device and transformation of the visual feed may be performed by a server in a network or a host device in wireless communication with the head mounted display. In further embodiments, a 3D camera or two cameras are mounted to the display to provide a stereoscopic visual feed.

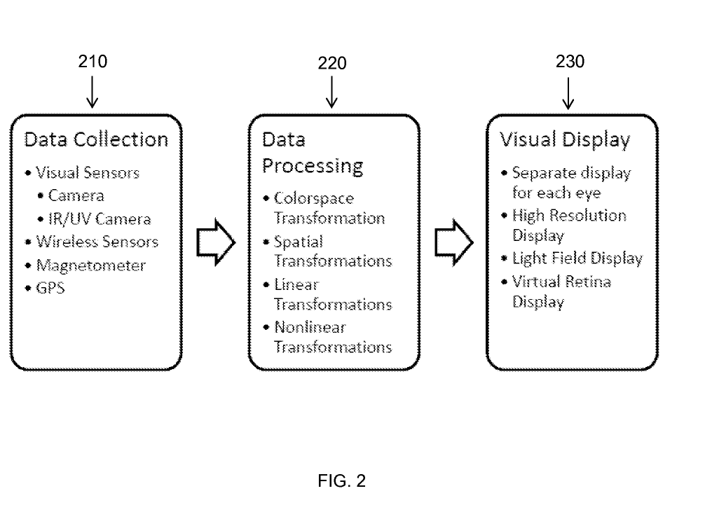

FIG. 2 is a flow diagram representing the stages involved in operation of an embodiment of the device. At stage (module) 210, the collection of data through a sensor or set of sensors occurs. The sensor can be a camera sensitive to visible light or to other spectra of light, such as ultraviolet or infrared. Additional sensors can include, for example, magnetometers, microphones, and GPS devices. The collected data provides a visual feed, and, optionally, additional feeds, such as sound. The collected data can be processed at stage (module) 220 through one or more transformations, such as, for example, linear transformations of spatial elements and visual/color transformations. Spatial elements include, for example, line and angle orientations, custom distortions on local or global regions, edge enhancements, and distances. The data processing stage or module 220 manipulates elements (e.g., color, spatial, etc.) of the raw visual feed, and optional additional feeds, to result in a modified, personalized visual feed. The personalized visual field is then presented on a visual display at stage (module) 230. The visual display can be, for example, a virtual retina display (e.g., a display that draws a raster display directly onto the retina of the eye), or a high resolution display.

In principle, a general class of transformations may help address a broad range of optical disorders. It is possible to apply several types of transformations to visual input by combining one or more cameras, one or more computer processors, and wearable display technology; all of which are becoming increasingly cheap and unobtrusive.

Systems and methods of the present invention can additionally incorporate a visual diagnostics stage or module, assessing such parameters as refractive error, field of vision, and contrast sensitivity. Compensatory image transformations that address the specific optical deficiencies of the user can then be selected and applied. Computer hardware capable of executing the algorithms for the compensatory image transformations on a streaming visual feed in real-time can be included.

A device can couple rapid visual diagnostics (assessing such parameters as refractive error, field of vision, and contrast sensitivity), algorithms for compensatory image transformation, and computer hardware for deploying the latter in real-time. In some embodiments, the device can take a form similar to an ordinary pair of glasses, or even be built into electronics embedded in a contact lens. Contact lenses with integrated LEDs and other embedded electronics can provide wearers with functions of a wearable computer. Examples of contact lenses with integrated electronics and LEDs include those developed at Google X, Sensimed, and Ulsan National Institute of Science and Technology.

In other embodiments, the device includes software running on a Smartphone that is mounted onto a headset and utilizing the camera and display components of the Smartphone to capture and present the visual feed. For example, headsets such as Google Cardboard and Oculus Gear VR may be utilized. In an alternative embodiment, a camera and a thin screen display are mounted onto a personalized headset, a pair of glasses, or an advanced contact lens display. Furthermore, the camera or input sensors, processing unit(s), and display may communicate wirelessly, such that a display can be included on, for example, a contact lens, while a camera and processing units are located elsewhere, for example, on a small head or earpiece worn by the user

### Data Collection Stage or Module 210

The device can include a visual sensor to detect light in the user's surrounding environment and provide a source for a raw visual feed. As an example, the visual sensor can be a Smartphone camera. Alternatively, or in addition, the device can include cameras capable of detecting light in nonvisible wavelengths, such as an ultraviolet-sensitive camera and an infrared-sensitive camera. Cameras with modified lenses (e.g., lenses configured to filter different wavelengths, or provide magnified or distorted images) can also be included. The device can further include other sensors, such as magnetometers, sound sensors, electric field sensors, and other sensors capable of providing a live data feed involving an aspect of a user's surrounding environment. For example, a sound sensor sensitive to high frequency sonar signals can be included. As such, the device can capture, in addition to information in the visual spectrum, sound, electricity, energy, and other such nonvisible information. For example, a magnetometer may be used to augment one's visual field by enhancing and presenting magnetic fields in one's visual display.

### Data Processing Stage or Module 220

The data processing stage involves the processing of the raw visual feed though one or more manipulations. These manipulations include, for example, linear transformations of pixel data, color remapping, and spatial distortions of the live feed.

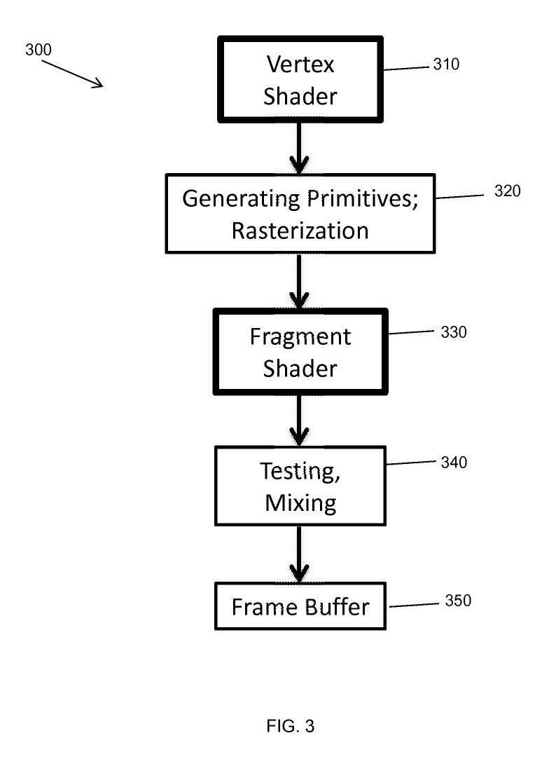

In order to provide image transformations on a streaming visual feed in real time to a user, the data processing module can include specialized hardware, such as GPUs, instead of, or in addition to, CPUs. For example, OpenGL for Embedded Systems (ES) can be used for fast rendering of 2D and 3D graphics by providing parallel processing. FIG. 3 illustrates an OpenGL ES pipeline for rendering graphics using GPUs. The pipeline 300 includes programmable shaders, Vertex Shader 310 (for manipulating spatial elements of the view) and Fragment Shader 330 (for manipulating colorspace elements of the view). From Vertex Shader 310, a setup of primitives and many fragments (corresponding to pixels) are processed in parallel at step 320 and passed to the Fragment Shader 330. From Fragment Shader 330, configurable operations of testing and mixing (i.e., covering pixels) are performed at step 340 and the resulting data are provided to Frame Buffer 350 that includes an array of pixels in which the computed fragments are stored prior to display. Use of an OpenGL ES pipeline for parallel processing is known in the art. The OpenGL ES pipeline is customizable for application to embodiments of the present invention.

Other processing environments, instead of or in addition to CPUs and GPUs may also be incorporated in module 220 or at the data processing stage. For example, if the visual display of the system is a holographic display, a Holographic Processing Unit (HPU) (Windows Holographic, Microsoft) can be included.

The computational transformations performed at the data processing stage can generate a modified, personalized visual feed that corrects or alleviates vision deterioration. For example, a common early stage of age-related macular degeneration is distortion of the visual field due to drusen (and other factors) as evidenced by the straight lines of an Amsler grid test appearing wavy to a person with the condition. This is the result of the slow migration of photoreceptors, such that their actual position deviates from where the brain “expects” them to be, leading to an inaccurate mental reconstruction of the visual field. By determining the deviations between the actual position of photoreceptors and this “mental map,” an inverse transformation can be applied, and the condition can be reversed.

Later stages of macular degeneration involve loss of vision in the center of the visual field while peripheral vision is maintained. Here, too, a computational transformation can shift images from the center of the visual field to the periphery so that users with the condition would be able to adapt to their loss of visual field. In other words, the device can deliver the visual field the user desires or needs into the visual field that the user has.

Other conditions can also be addressed. For instance, there is no cure for color-blindness. But, through computational correction (daltonization), colors can be remapped so that those affected by color-blindness can maximize their ability to benefit from chromatic contrasts even given a limited chromatic palette. Similarly, there is an extremely high prevalence of cataracts around the world, despite the availability of a corrective surgery. In some parts of the world, the prevalence of cataracts is due to the cost of surgery and lack of doctors. Computational tuning of contrast may help alleviate such a condition.

In order to correct vision for individuals with visual deficits not presently correctable with traditional glasses, embodiments of the present invention employ computational transformation of a visual feed to manipulate color space and/or visuospatial elements and provide an enhanced view for the individual. The manipulation of the visual feed can include, for example, augmenting colors, introducing corrective distortions, and performing offsets to elements in the visual feed. The process of calculating the corrective transformations can include diagnostic techniques described below.

Furthermore, embodiments of the present invention are not limited to providing corrections for optical deficiencies and medical conditions, or even improving an individual's vision. Embodiments of the present invention can intentionally alter an individual's vision for non-medical or recreational use by the user. For example, an individual may desire to enhance the color pink within his or her visual field or view the world as someone with macular degeneration might. To enhance a particular color, a colorspace transformation can be applied.

### Visual Display Stage or Module 230

At the visual display stage, the modified and transformed visual feed, e.g. the personalized visual feed, is displayed to the user. The personalized visual feed may be presented on a phone screen, mediated reality headset, or any other potential electronic screen that is capable of displaying the visual feed. The visual display can be configured to be worn by the user. Alternatively, the visual display can be a non-wearable device, such as a smart windshield (e.g., Virtual Urban Windscreen by Jaguar, Land Rover, and Head-Up Display by BMW).

In order to address a wide variety of optical deficiencies, as well as personalization by the user, the device and software allow for the different visual feeds to be presented to each of the user's eyes. For example, a visual feed may be subject to different modifications in order to be viewed by an individual with macular degeneration as each eye may require a different type of distortion. As a further example, UV and electric field sensors can be included and their respective feeds processed to allow visualization of the UV spectrum and electric fields, which can be presented to a user's left eye. Data feeds from an infrared camera and a microphone array, also included, can be processed to present to the user's right eye infrared and visible color images, with an overlay of Doppler enhanced edges.

To provide stereoscopic viewing to the user at the visual display stage, two cameras may be included in the data collection module to provide two visual feeds, one for each eye, with each of the two produced personalized visual feeds presented on a separate display. Alternatively, a 3D camera may be included in the data collection module, or computational methods for mimicking a second camera can be performed in the data processing module to produce two visual feeds.

### Diagnostic Testing or Module

In order to identify and/or develop the necessary transformations to improve a user's vision, a variety of diagnostic tools can be included, such as automated Amsler grids which compute the spatial transform to un-distort a user's vision or color organization tests which compute color deficits or color blindness.

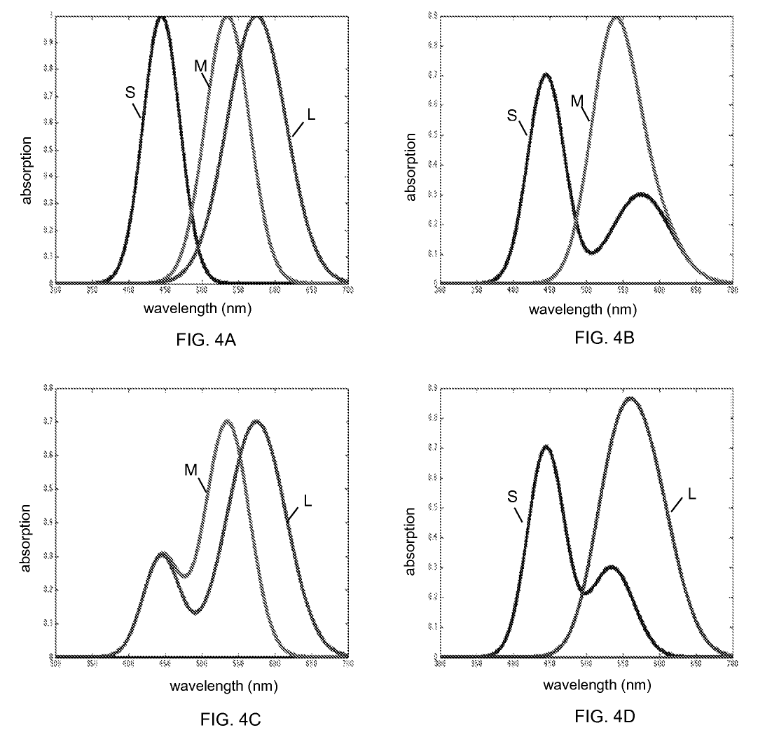

For example, a person without colorblindness can detect colors across the visual spectrum. The response of the three types of cones (photoreceptor cells) of the human eye for a person with normal color vision is shown in FIG. 4A, with responsivity at short (S), medium (M), and long (L) wavelengths. Some individuals lack one or more of the S, M, and L cone types, as shown in FIGS. 4B-4D, and, as such, are unable to see color(s) at wavelengths corresponding to the missing receptors.

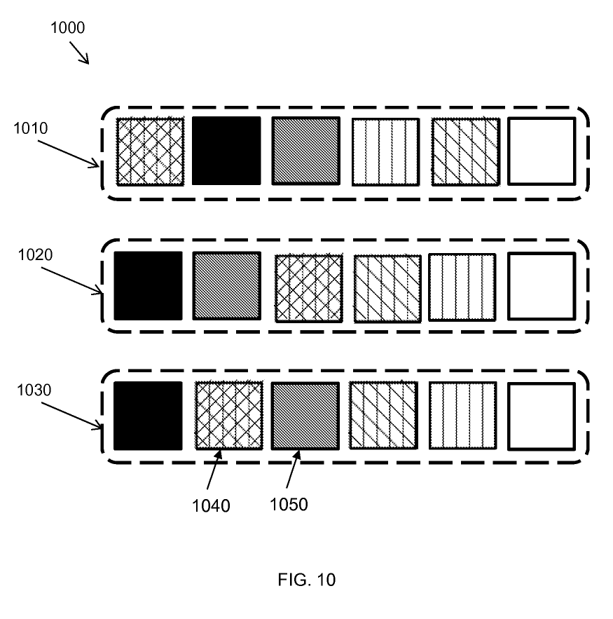

Various diagnostic tools involved in constructing the necessary corrective transformations can be employed. FIG. 10 illustrates a diagnostic tool of an embodiment of the present invention. The diagnostic tool 1000 includes a series of colors that are displayed to the user and that can be used to detect the different types of color deficiencies. For example, a randomly organized series 1010 of color tiles with mixed shades of red and green is initially presented to the user in the diagnostic tool 1000, with each color tile representing a different red or green mixed hue. In FIG. 10, the tile containing the most red is represented in black and the tile containing the most green is represented in white. The user is then tasked with arranging the colored tiles such that the tiles are organized along a gradient according to color, e.g., from red hues to green hues. The correct result appears in the organized series 1020, in which the tiles are properly arranged and a gradient of red to green hues can be seen. An individual with a color deficiency in red and/or green may have trouble completing this task, and his or her resulting arrangement of colors is likely to be out of order, as shown in series 1030 with the incorrect arrangement of tiles 1040 and 1050. A diagnostic module of the present invention can perform several iterations of such tests and detect the particular color deficiency or deficiencies of the user, for example, by assessing the degree by which the user's ordering varies from a reference value or norm. The information obtained from the diagnostic module, for instance, the relative mix of hues in the incorrectly ordered colors, can be provided to the transformation module to produce a personalized visual feed unique to the user. Color transformations are further described below.

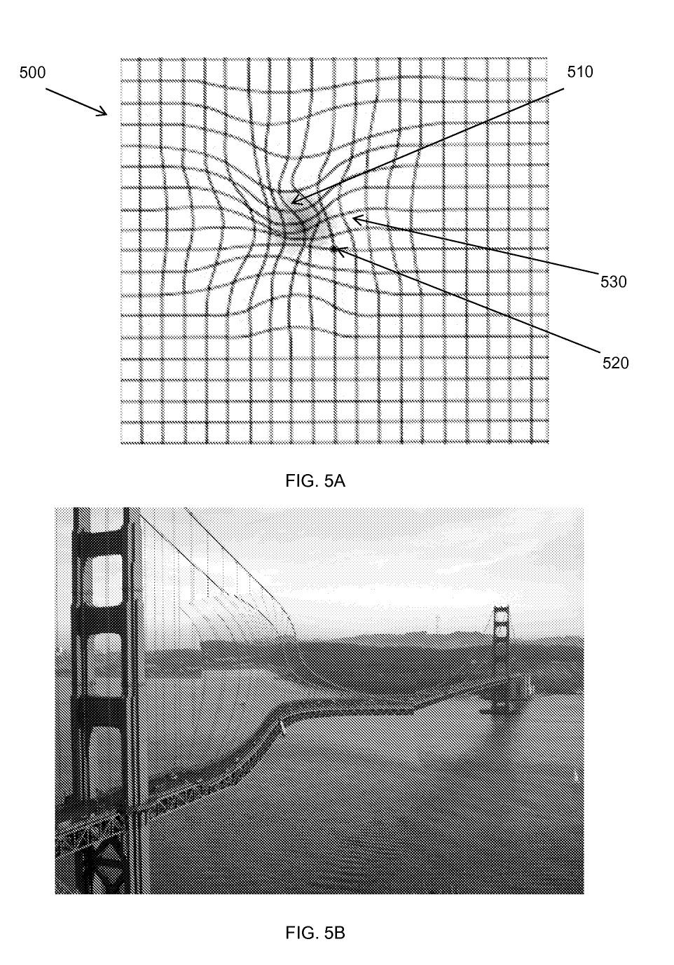

In another example, an Amsler grid 500 representing the spatial distortions viewed by a individual with, for example, macular degeneration or cataracts, is shown in FIG. 5A. During an Amsler test an individual is provided with a grid having straight horizontal and vertical lines. The grid, in its original state, appears distorted to the individual with the condition, such as macular degeneration or cataracts. The individual drags points of intersection between the lines, such as point 530, to create distortions 520 until the grid appears straight to the user. Macular degeneration typically begins with distorted vision and eventually progresses to loss of central vision, represented by shaded area 510. While late stage loss of vision is untreatable, distortions can be correctable. FIG. 5B illustrates an example of a perceived view of an individual with distorted vision, such as shown in FIG. 5A.

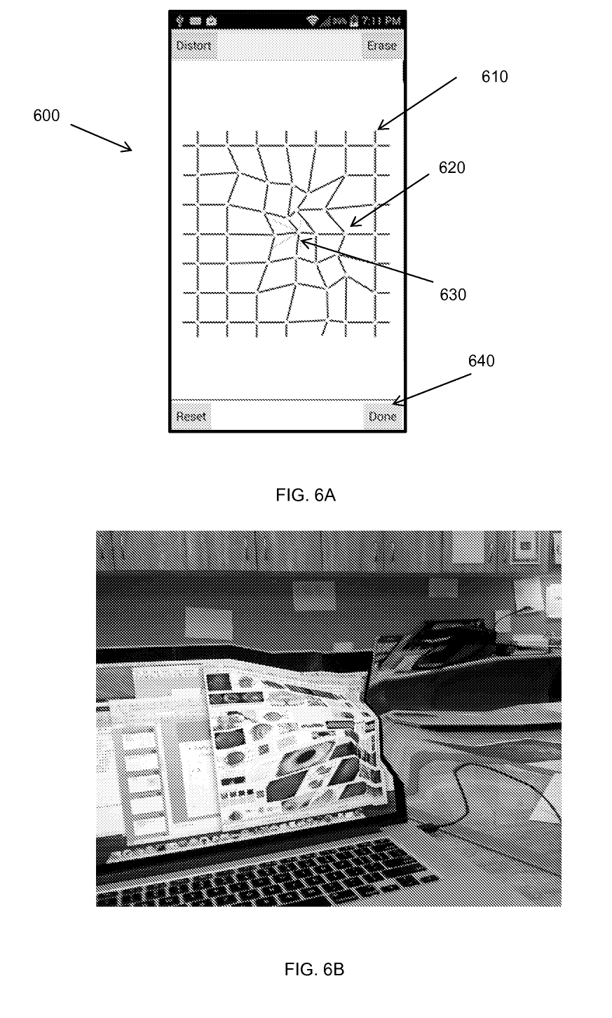

FIG. 6A illustrates a diagnostic tool of an embodiment of the present invention. A graphical user interface 600 is provided containing an Amsler grid 610. A user manipulates points 620 to capture the distortion seen by the user. Lines 630 are used to point at the center of the image. The diagnostic test is performed with the user holding the grid away from his or her face, covering one eye, and staring at the center of the grid, as indicated by lines 630, while manipulating points 620. The test can then be repeated with the other eye and at multiple distances. Buttons 640 provide the user with controls to further interact with the diagnostic tool, such as, for example, to reset the Amsler grid and save the user input. Following user input of the distortions, the device performs a computational transformation, such as an inverse transform, to present to the user a personalized visual feed that appears undistorted to the user. An example of an image from a personalized visual feed is shown in FIG. 6B.

Rapid visual diagnostics might take the form of automated, interactive versions of traditional eye-tests, such as letter-based exams, contrast-sensitivity exams, visual field assessments and the Amsler grid. The analysis of retinal images like those seen through an ophthalmoscope might also be automated. For example, an image taken of the eye can be used to observe regions of the retina that are torn or damaged. The images can be used to identify likely regions from which distortions are occurring. Devices and methods of the present invention can include an additional camera for detecting images of a user's retina and a diagnostic module can be provided to identify regions where retrial damage is present.

To utilize embodiments of the present invention, users can first be provided with an initial battery of visual tests, including tests such as the Landolt C, Amsler Grid, Ishihara, Depth Perception, and Reaction Time tests. This initial battery of tests can be provided in a standard manner, with the user wearing his or her prescribed eyewear, and/or through an automated manner while wearing a device of the present invention. Tests using the device of the present invention can be conducted in an automated computerized manner. The tests performed by the device do not require any invasive or dangerous procedures.

The Landolt C test is a standardized vision test in which a Landolt ring symbol (C) is presented to the individual in various sizes and orientations to test for visual acuity (e.g., blurred vision, nearsightedness, and farsightedness). The Amsler Grid test is a standardized vision test composed of a grid and horizontal and vertical lines for measuring distortions and visual disturbances caused by changes in the retina (e.g., due to accumulation of drusen or eye injuries). The Ishihara/Color Plate test is a color vision deficiency test for measuring different forms of color blindness and color perception. The Depth Perception test presents contour and random dot stereograms for measurement of a subject's stereo vision. Reaction Time tests provide a measurement of a subject's reaction times for a variety of visual/haptic/audio stimuli.

It is not necessary to diagnose the user with a specified disease or condition. Rather, a general series of tests can be used to detect visual deficiencies and/or preferences of the user, and general transformations (e.g., shifting, rotating, distorting, filtering, color transforming, adding, and subtracting) can be applied to generate a personalized visual feed that corrects for a wide variety of visual deficiencies. While devices and methods of the present invention can improve vision for users with visual deficiencies or aberrations, providing them with a therapeutic benefit, the devices and methods of the invention can also be used to alter vision for users without visual deficiencies. A diagnostic testing module can be incorporated into the device or system to tailor a personalized visual feed for any user.

### Example Transformations

Upon completion of the diagnostic test or selection by the user, a transformation, or more than one transformation is applied to the raw visual feed. Examples of transformations to treat given optical deficiencies or otherwise provide a personalized feed are described.

Colorblindness: To improve the vision of a user with colorblindness a colorspace transform, M*c1→c2, can be applied to the raw visual feed, as follows where M is a matrix representing a colorspace transform (e.g. a daltonized transform) and c1 and c2 represent, respectively, an initial color of the visual feed and a resulting transformed color of the personalized visual feed. The transformation provides a daltonized computational correction.

Motion Detection: To provide a user with an improved ability to view motion, a transformation can be performed in which a previous frame is subtracted from a current frame to locate motion, and those located areas are visually enhanced.

Macular Degeneration: To improve vision for a user with macular degeneration, a transformation to spatially distort the image grid using coordinate translation, as determined by diagnostic testing of the subject, can be performed.

Impossible Colors and Retinal Rivalry: The right eye of a user can be presented with a visual feed in standard RGB colors, while a transform remapping RGB→BGR is applied to the visual feed presented to the left eye of the user.

Magnetic Field: The device can calculate the strength of a magnetic field in a forward direction and perform a transformation in which the visual field is distorted based on a direction and strength of the magnetic field.

An example of a transformation module is shown in the following pseudocode. The device transforms the raw visual feed according to a function f and displays the modified visual feed to the right and left eyes of the user.

while(true)
Img <- preview image from Android Camera
// parallelized by running on GPU
for i in 0 to Img.width
for j in 0 to Img.height
// f is transform
Img2(i,j) = f(Img(i,j))
A <- right_eye_transform(Img2)
B <- left_eye_transform(Img2)
display_to_split_screen(A,B)

An example of the transformation module incorporating a motion detection transformation is shown in the following pseudocode.

Img0 <- preview image from Android Camera
while(true)
Img1 <- preview image from Android Camera
// parallelized by running on GPU
for i in 0 to Img0.width
for j in 0 to Img0.height
// f is motion transform
Img2(i,j) = f(Img0(i,j), Img1(i,j))
A <- right_eye_transform(Img2)
B <- left_eye_transform(Img2)
display_to_split_screen(A,B)
Img0 <- Img1

An example of the transformation module performing a daltonization transformation is shown in the following OpenGL code, which performs the equivalent of the M*c1→c2 transformation described above. For example, c1 is represented by tex.rgba and c2 is represented by g1_FragColor in the code below. The multiplication by M is broken up using vectors.

precision mediump float;
varying vec2 textureCoordinate;
uniform sampler2D texture1;
const vec2 gcoeff = vec2(−0.255, 1.255);
const vec3 bcoeff = vec3(0.30333, −0.545, 1.2417);
void main( ) {
vec4 tex = texture2D( texture1, textureCoordinate );
float g2 = dot(tex.rg, gcoeff);
float b2 = dot(tex.rgb, bcoeff);
gl_FragColor = vec4(tex.r, g2, b2, tex.a);
}

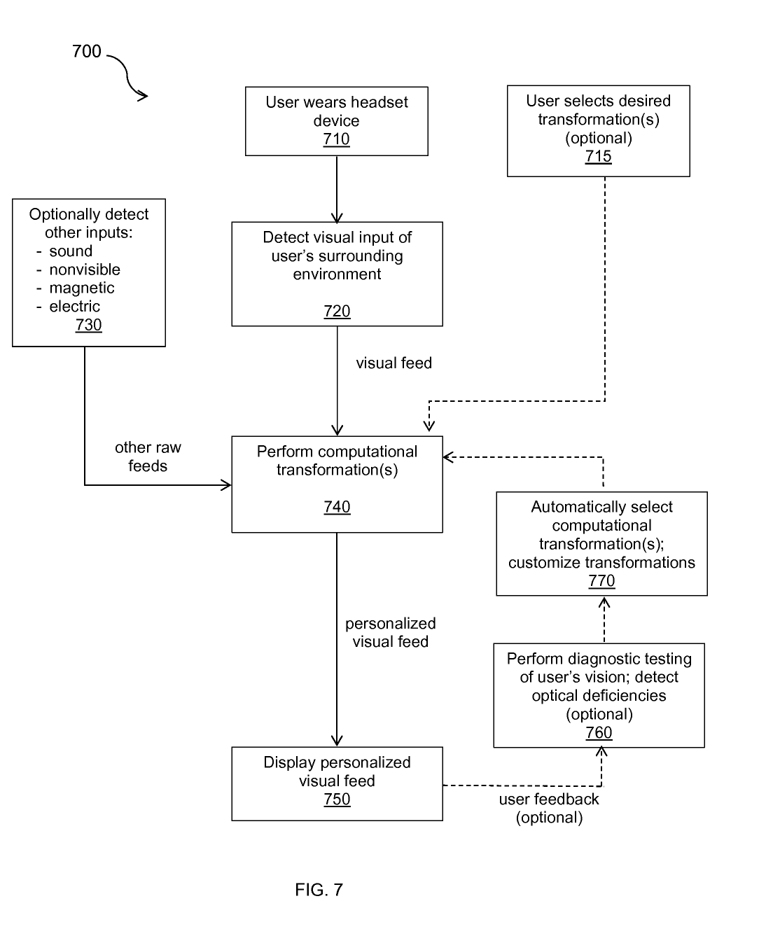

FIG. 7 is a flow chart illustrating a method 700 of the present invention. Initially, at 710, a user wears a headset device equipped with at least a visual sensor and a visual display. In alternative embodiments, the visual sensor may be separate from the headset device, for example, mounted on a hat or glasses, and be in wireless communication with other components. At 720, a visual input is detected by the visual sensor to provide a visual feed that includes information regarding the user's surrounding environment. Additional sensors may be included on or within the device, or worn separately by the user. At 730, such optional sensors can detect additional feeds, such as sound, light in nonvisible wavelengths, magnetic fields, and electric fields. The visual sensor, together with any optional sensors, can compose a sensor module. The user may further make a selection as to a desired transformation to be performed on the raw feed(s), as shown at 715.

At 740, at least one computational transformation is performed on the raw visual feed and any other additional raw feeds, generating a personalized visual feed. At 750, the personalized visual feed is displayed to the user. The computational transformation(s) performed can be selected by the user (715), as noted above, or the computational transformation(s) can be automatically selected by a processor based on diagnostic testing of the individual, as shown at 760 and 770.

A diagnostic module to perform testing on a user's vision can be performed automatically or can employ an iterative process that includes presenting a first personalized display to a user based upon an initial computational transformation, receiving feedback from the user, revising the computational transformation, and presenting a second personalized display to a user. The process can be repeated as often as needed to produce an optimized personal display to the user.

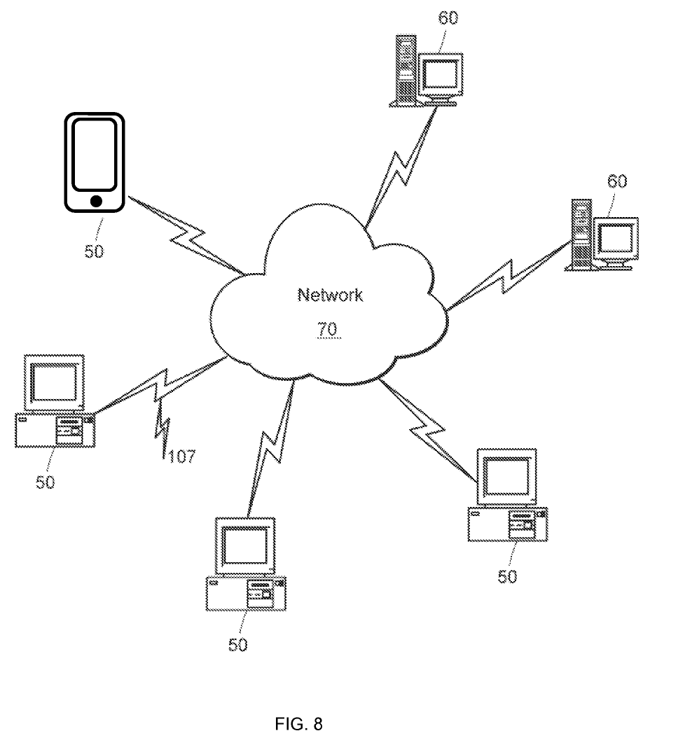

FIG. 8 illustrates a computer network or similar digital processing environment in which embodiments of the present invention may be implemented.

Client computer(s)/devices 50 (e.g., tablet, smartphone, laptop, desktop, PDA, etc.) and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

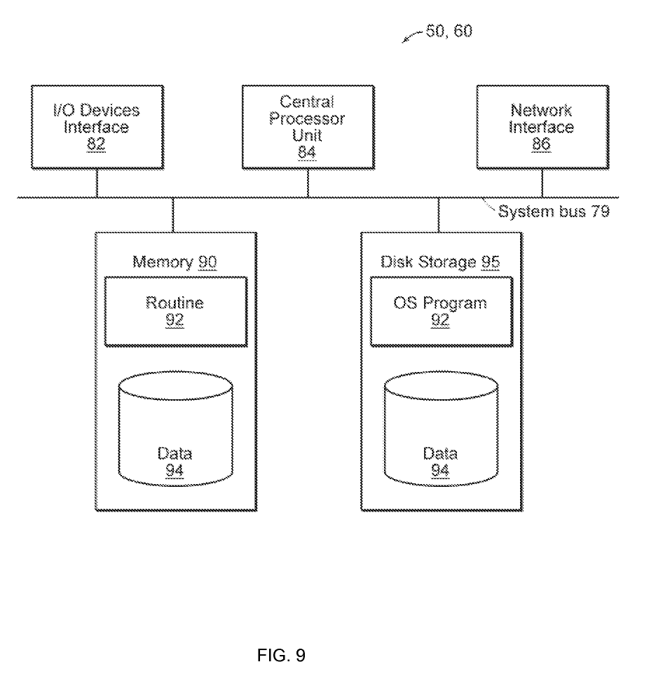

FIG. 9 is a diagram of the internal structure of a computer (e.g., client processor/device 50 or server computers 60) in the computer system of FIG. 8. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., cameras, sensors, keyboard, mouse, displays, printers, speakers, etc.) to the computer 50, 60. Network interface 86 allows the computer to connect to various other devices attached to a network (e.g., network 70 of FIG. 8). Memory 90 provides volatile storage for computer software instructions 92 and data 94 used to implement an embodiment of the present invention (e.g., computational transformations and data processing 220, such as the color transformation code detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. A device for presenting a personalized visual feed to a user, the device comprising:
a sensor module including a visual sensor to detect a visual input, the sensor module providing a visual feed based on the detected visual input;
a transformation module configured to receive the visual feed, the transformation module performing a computational transformation on at least a portion of the received visual feed to produce a personalized visual feed, the computational transformation being selected according to at least one of a visual deficit and a preference of the user; and
a visual display presenting the personalized visual feed to the user.

2. The device of claim 1 wherein the visual feed includes a series of images, and wherein the transformation module performs the computational transformation on at least a portion of each of the images.

3. The device of claim 1 wherein the visual display includes at least one of a light field display and a virtual retina display.

4. The device of claim 1 wherein the visual display provides a separate display for each eye of the user.

5. The device of claim 1 wherein the visual display is mounted on or within a contact lens.

6. The device of claim 1 wherein the visual sensor includes one or more cameras that detect light in a visible spectrum.

7. The device of claim 1 wherein the visual sensor includes one or more cameras that detect light in at least one spectral band other than a visible spectrum.

8. The device of claim 1 wherein the sensor module further includes a non-visual sensor, the transformation module using data from the non-visual sensor to produce the personalized visual feed.

9. The device of claim 8 wherein the non-visual sensor includes at least one of a microphone, GPS sensor, gyroscope, magnetometer, and compass.

10. The device of claim 8 wherein the transformation module uses the data from the non-visual sensor to augment the user's visual field by altering a portion of the visual feed to visualize the data from the non-visual sensor.

11. The device of claim 1 wherein the computational transformation is selected according to a visual deficit of the user.

12. The device of claim 11 wherein the computational transformation includes a color transformation.

13. The device of claim 12 wherein the visual deficit of the user includes color blindness or color deficiency, and wherein the color transformation results in the personalized visual feed providing improved color contrast for the user.

14. The device of claim 11 wherein the computational transformation includes a spatial distortion.

15. The device of claim 14 wherein the visual deficit of the user includes macular degeneration, and wherein the spatial distortion results in the personalized visual feed providing improved vision for the user.

16. The device of claim 11 wherein the visual deficit includes an optical aberration in one or both eyes of the user, and wherein the computational transformation includes a transformation to correct for the optical aberration.

17. The device of claim 1 wherein the computational transformation includes at least one of spatially translating, spatially rotating, and spatially distorting at least a portion of the visual feed.

18. The device of claim 1 wherein the computational transformation includes at least one of a linear and non-linear transformation of at least a portion of the visual feed.

19. The device of claim 1 further comprising a wireless communication interface.

20. The device of claim 19 wherein at least one of the sensor module, the transformation module, and the visual display module communicate wirelessly via the wireless interface.

21. The device of claim 1 further comprising a diagnostic module configured to automatically select the computational transformation performed by the transformation module.

22. The device of claim 21 wherein the computational transformation is selected in an interactive process that includes automatically administering one or more eye tests to the user and determining the at least one of a visual deficit and a preference of the user as a result of the one or more eye tests.

23. The device of claim 1 further comprising a selection module configured to enable selection of the computational transformation performed by the transformation module.

24. The device of claim 23 wherein the computational transformation is selected in response to user input.

25. The device of claim 1 wherein the device is a wearable device, and wherein at least one of the sensor module, transformation module and visual display is mounted to a headset configured to the be worn by the user.

26. The device of claim 1 wherein the transformation module performs the computational transformation to produce the personalized visual feed for one eye of the user, and a different computational transformation to produce a different personalized visual feed for the other eye of the user.

27. A method for presenting a personalized visual feed to a user, the method comprising:
providing a visual feed based on visual input detected by a visual sensor;
in at least one processor,
receiving the visual feed from the visual sensor, and
performing a computational transformation on at least a portion of the received visual feed to produce a personalized visual feed, the computational transformation being selected according to at least one of a visual deficit and a preference of the user; and
presenting the personalized visual feed to the user on a visual display.

28. The method of claim 27 wherein the visual feed includes a series of images, and wherein the computational transformation is performed on at least a portion of each of the images.

29. The method of claim 27 wherein the visual display includes at least one of a light field display and a virtual retina display.

30. The method of claim 27 wherein a separate display is provided to each eye of the user.

31. The method of claim 27 wherein the visual display is mounted on or within a contact lens.

32. The method of claim 27 wherein the visual sensor detects light in a visible spectrum.

33. The method of claim 27 wherein the visual sensor detects light in at least one spectral band other than a visible spectrum.

34. The method of claim 27 further comprises providing at least one feed based on a non-visible input detected by a non-visual sensor.

35. The method of claim 34 wherein the non-visual sensor includes at least one of a microphone, GPS sensor, gyroscope, magnetometer, and compass.

36. The method of claim 34 further comprising altering a portion of the visual feed to visualize data from the non-visual sensor.

37. The method of claim 27 wherein the computational transformation is selected according to a visual deficit of the user.

38. The method of claim 37 wherein the computational transformation includes a color transformation.

39. The method of claim 38 wherein the visual deficit of the user includes color blindness or color deficiency, and wherein the color transformation results in a personalized visual feed providing improved color contrast for the user.

40. The method of claim 37 wherein the computational transformation includes a spatial distortion.

41. The method of claim 40 wherein the visual deficit of the user includes macular degeneration and wherein the spatial distortion results in the personalized visual feed providing improved vision for the user.

42. The method of claim 37 wherein the visual deficit includes an optical aberration in one or both eyes of the user, and wherein the computational transformation includes a transformation to correct for the optical aberration.

43. The method of claim 27 wherein the computational transformation includes at least one of spatially translating, spatially rotating, and spatially distorting at least a portion of the visual feed.

44. The method of claim 27 wherein the computational transformation includes at least one of a linear and non-linear transformation of at least a portion of the visual feed.

45. The method of claim 37 further comprising performing a diagnostic assessment of the user to automatically select the computational transformation.

46. The method of claim 45 wherein performing the diagnostic assessment includes automatically administering one or more eye tests to the user and determining the at least one visual deficit of the user as a result of the one or more eye tests.

47. The method of claim 45 wherein performing the diagnostic assessment includes an iterative process of presenting a first personalized visual feed to the user, receiving feedback from the user, performing an adjusted computational transformation based on the received feedback from the user to produce a second personalized visual feed, and presenting the second personalized visual feed to the user.

48. The method of claim 27 wherein the computational transformation is selected in response to user input.

49. The method of claim 27 wherein the visual sensor, the at least one processor, and the visual display are included in a wearable device.

50. The method of claim 49 wherein the wearable device is a headset configured to be worn by the user.

51. The method of claim 27 wherein the computational transformation is performed to produce the personalized visual feed for one eye of the user, and a different computational transformation is performed to produce a different personalized visual feed for the other eye of the user.

52. A computer system for presenting a personalized visual feed to a user, the computer system comprising:
a sensor module including a visual sensor to detect a visual input, the sensor module providing a visual feed based on the detected visual input;
a visual display; and
at least one processor configured to:
receive the visual feed from the sensor module;
perform a computational transformation on at least a portion of the received visual feed to produce a personalized visual feed, the computational transformation being selected according to at least one of a visual deficit and a preference of the user; and
present the personalized visual feed on the visual display to the user.

53. The computer system of claim 52 wherein the visual feed includes a series of images, and wherein the at least one processor performs the computational transformation on at least a portion of each of the images.

54. The computer system of claim 52 wherein the visual display includes at least one of a light field display and virtual retina display.

55. The computer system of claim 52 wherein the visual display provides a separate display for each eye of the user.

56. The computer system of claim 52 wherein the visual display is mounted on or within a contact lens.

57. The computer system of claim 52 wherein the visual sensor includes one or more cameras that detect light in a visible spectrum.

58. The computer system of claim 52 wherein the visual sensor includes one or more cameras that detect light in at least one spectral band other than a visible spectrum.

59. The computer system of claim 52 wherein the sensor module further includes a non-visual sensor, the at least one processor using data from the non-visual sensor to produce the personalized visual feed.

60. The computer system of claim 59 wherein the non-visual sensor includes at least one of a microphone, GPS sensor, gyroscope, magnetometer, and compass.

61. The computer system of claim 59 wherein the at least one processor uses the data from the non-visual sensor to augment the user's visual field by altering a portion of the visual feed to visualize the data from the non-visual sensor.

62. The computer system of claim 52 wherein the computational transformation is selected according to a visual deficit of the user.

63. The computer system of claim 62 wherein the computational transformation includes a color transformation.

64. The computer system of claim 63 wherein the visual deficit of the user includes color blindness or color deficiency, and wherein the color transformation results in the personalized visual feed providing improved color contrast for the user.

65. The computer system of claim 62 wherein the computational transformation includes a spatial distortion.

66. The computer system of claim 65 wherein the visual deficit of the user includes macular degeneration and wherein the spatial distortion results in the personalized visual feed providing improved vision for the user.

67. The computer system of claim 62 wherein the visual deficit includes an optical aberration in one or both eyes of the user, and wherein the computational transformation includes a transformation to correct for the optical aberration.

68. The computer system of claim 52 wherein the computational transformation includes at least one of spatially translating, spatially rotating, and spatially distorting at least a portion of the visual feed.

69. The computer system claim 52 wherein the computational transformation includes at least one of a linear and non-linear transformation of at least a portion of the visual feed.

70. The computer system of claim 52 further comprising a wireless communication interface.

71. The computer system of claim 70 wherein at least one of the sensor module, the at least one processor, and the visual display communicate wirelessly via the wireless interface.

72. The computer system of claim 52 further comprising a diagnostic module configured to automatically select the computational transformation performed by the at least one processor.

73. The computer system of claim 72 wherein the computational transformation is selected in an interactive process that includes automatically administering one or more eye tests to the user and determining the at least one of a visual deficit and a preference of the user as a result of the one or more eye tests.

74. The computer system of claim 52 further comprising a selection module configured to enable selection of the computational transformation performed by the at least one processor.

75. The computer system of claim 74 wherein the computational transformation is selected in response to user input.

76. The computer system of claim 52 wherein the device is a wearable device, and wherein at least one of the sensor module, the at least one processor and the visual display is mounted to a headset configured to be worn by the user.

77. The computer system of claim 52 wherein the at least one processor performs the computational transformation to produce the personalized visual feed for one eye of the user, and a different computational transformation to produce a different personalized visual feed for the other eye of the user.

78. The computer system of claim 52 wherein the visual display is configured to be worn by the user.
